(19) United States
(12) Patent Application Publication
(10) Pub. No.: US 2007/0068735 A1
(43) Pub. Date: Mar. 29, 2007

(54) Axle interior lubricating device

(76) Inventors: Kinya Mori, Tochigi (JP); Nobufumi Ichihara, Tochigi (JP); Yoshitaka Baba, Tochigi (JP)

Correspondence Address: EVEREST INTELLECTUAL PROPERTY LAW GROUP, P. O. BOX 708, NORTHBROOK, IL, 60065, US

(21) Appl. No.: 10/575,729

(22) PCT Filed: Sep. 29, 2004
(86) PCT No.: PCT/JP04/14236

§ 371 Date: Apr. 13, 2006

(30) Foreign Application Priority Data
Oct. 21, 2003 (JP) 2003-360142

(51) Int. Cl. F16H 57/04

(52) U.S. Cl. 184/6.12

(57) ABSTRACT

A suction inlet port (48) is formed in an inner peripheral surface on a bottom portion side of a differential housing (15), and the suction inlet port (48) is connected to a suction outlet port (42) formed in an outer peripheral surface of the differential housing (15) via a suction pipe line (43). The suction outlet port (42) is formed in a mounting seat (16) to which a lubricating pump (30) is attached. A discharge port (44) introducing lubricating oil discharged from the lubricating pump (30) is formed in an upper position of the mounting seat (16), and a discharge pipe line 45 is connected to the discharge port (44). Each of a first discharge port (46) and a second discharge port (47) is formed in an end portion of the discharge pipe line (45). The suction pipe line (43) and the discharge pipe line (45) are formed integrally with the differential housing (15) by casting or the like.

### TECHNICAL FIELD

The present invention relates to a lubricating device for lubricating a drive apparatus stored within an axle housing of a wheeled vehicle.

### BACKGROUND ART

Conventionally, as a lubricating device for lubricating a drive apparatus stored within an axle housing of a wheeled vehicle, for example, there have been proposed a lubrication adjusting type limited-slip differential (refer to patent document 1), a pressure lubricating device (refer to patent document 2) and the like.

FIG. 13 shows a cross sectional view of a structure of a main portion of the lubrication adjusting type differential limiting device described in the patent document 1. The lubrication adjusting type limited-slip differential is structured as a center differential provided with a planetary gear type center differential 70 and a hydraulic multiple disc clutch 80 serving as a limited-slip differential mechanism.

The planetary gear type center differential 70 is provided with a ring gear 78A, a planetary pinion 78B, a sun gear 78C and a planetary carrier 78D. The structured is made such that a driving force is input to the ring gear 78A from an engine (not shown) via a transmission.

The driving force is allocated to a rear wheel side from the planetary carrier 78D via the planetary pinion 78B working with the ring gear 78A. Further, the driving force is allocated to a front wheel side from the ring gear 78A and the sun gear 78C working with the planetary pinion 78B. A hollow shaft 71 is serration coupled to a hollow member 72 to which a rear wheel driving ring gear 84A is installed by a bolt 83.

A hollow shaft 73 is serration coupled to a front differential case 75 of a front differential 74. A side gear 88C is installed so as to integrally rotate with a left front wheel drive shaft 89L, and a side gear 88D is installed so as to integrally rotate with a right front wheel drive shaft 89R.

The hydraulic multi disc clutch 80 is provided between a rear wheel side member 76 coupled to the hollow member 72, and a front wheel side member 77 coupled to the front differential case 75. An internal contact type gear pump 81 is provided between the rear wheel side member 76 and the front wheel side member 77 which can differentially move with each other.

The gear pump 81 is arranged coaxially with the right front wheel drive shaft 89R coupled to the front differential 74, and is driven in correspondence to a differential state between the rear wheel side member 76 and the front wheel side member 77. It is possible to supply a lubricating oil from an inner side of the hydraulic multi disc clutch 80 toward an outer side thereof, by an actuation of the gear pump 81. Accordingly, it is possible to supply the lubricating oil to the hydraulic multi disc clutch 80, it is possible to suppress generation of an agitating resistance due to the lubricating oil, and it is possible to improve a durability of a friction plate in the hydraulic multi disc clutch 80.

FIG. 14 shows a back view of a pressure lubricating apparatus described in the patent document 2. A lubricating pump 91 is connected to a pipe joint 94 existing in a base bottom portion of a housing 90 via a feed oil pipe 92. The pipe joint 94 is externally piped in a rear wall along a rear wall 93. Accordingly, the lubricating pump 91 can suck the lubricating oil from an oil receiver (not shown) within the base bottom portion of the housing 90 via the pipe joint 94.

However, in the lubrication adjusting type limited-slip differential described in the patent document 1, since the structure is made such that the lubricating gear pump 81 is arranged coaxially with the drive shaft 89R, and is provided between the front wheel side member 77 and the rear wheel side member 76, it is necessary that the gear pump 81 is structured as a lubricating pump provided with a special structure. Further, since the structure as the gear pump 81 is complicated, and assembling work thereof is complicated, there is a problem that the manufacturing cost of the front wheel drive apparatus is increased.

Further, when the gear pump 81 gets out of order, it is necessary to disassemble the front wheel drive apparatus so as to repair the gear pump 81. Accordingly, a lot of working steps are required for the repair. Further, since no strainer is arranged in a lubricating oil suction side of the gear pump 81, a foreign particle or the like is sucked into the gear pump 81, so that there is a risk that the gear pump 81 or the drive apparatus is damaged by the sucked foreign particle or the like. Further, there is a problem that in the case that it is necessary to increase a cooling capacity of the lubricating oil, it is hard to correspond thereto.

In the pressure lubricating apparatus described in the patent document 2, a filter is provided in the pipe joint 94. However, since the feed oil pipe 92 connecting the pipe joint 94 and the lubricating pump 91 is arranged on an outer side of the rear wall 93, there is a risk that the feed oil pipe 92 is broken if the feed oil pipe 92 is brought into contact with an external obstacle, and there is a problem that the lubricating oil flows out to the outside due to the breakage of the feed oil pipe 92. In particular, in order to arrange the feed oil pipe 92 on a housing of the center differential having a high risk of being brought into contact with the external obstacle, it is independently necessary to apply a countermeasure that the piping portion is covered by a protection cover.

Patent document 1: Japanese Patent Laid-Open Publication No. 5-262150

Patent document 2: Japanese Patent Laid-Open Publication No. 57-40164

### DISCLOSURE OF THE INVENTION

Problem to be Solved by the Invention

An object of the present invention is to provide a lubricating apparatus in which a piping for lubrication is not damaged even if it is brought into contact with an external obstacle, a lubricating pump is easily repaired at a time of getting out of order, and there is no risk that a lubricating pump or a drive apparatus is damaged by a foreign particle or the like mixing in the lubricating oil.

Means for Solving the Problem

In accordance with a most main aspect of the present invention, in order to achieve the object mentioned above, there is provided with an axle interior lubricating device for a vehicular axle, being characterized in that a suction inlet port formed in an inner peripheral surface on a bottom portion side of the axle housing, a suction outlet port formed in an outer peripheral surface of the axle housing at an upper position than a forming position of the suction inlet port, and a suction pipe line communicating the suction inlet port with the suction outlet port are formed integrally with the axle housing, and the suction outlet port is connected to a lubricating pump.

Further, in accordance with a main aspect of the present invention, at least two discharge ports are formed in the outer peripheral surface of the axle housing at different positions above a forming position of the suction inlet port, the discharge ports and a discharge pipe line communicating the respective discharge ports are formed integrally with the axle housing, and discharge pressure oil from the lubricating pump is supplied to one of the discharge ports.

Further, in accordance with main aspects of the present invention, the lubricating pump is arranged on the outer peripheral surface of the axle housing, the lubricating pump comprises a reversible type pump and is driven by a driving force of the drive apparatus, and the lubricating pump is an electric motor-driven lubricating pump.

Further, in accordance with a main aspect of the present invention, a strainer for filtering lubricating oil is inside installed within the suction pipe line.

Effect of the Invention

The axle interior lubricating device in accordance with the present invention is provided with the suction pipe line formed integrally with the axle housing as at least a part of the pipe line sucking the lubricating oil within the axle housing to the lubricating pump.

Accordingly, even if the bottom portion of the axle housing is brought into contact with the external obstacle during the travel of the vehicle or the like, there is no risk that the suction pipe line is damaged by the obstacle, and it is possible to improve a reliability and a durability serving as the axle interior lubricating device.

It is possible to employ the structure in which the discharge port is formed in the upper side of the forming position of the suction inlet port in the outer peripheral surface of the axle housing and the discharge port is communicated by the discharge pipe line, and the structure in which at least a part of the supply pipe line arranged for supplying to the drive apparatus is formed within the axle housing. Accordingly, even if a part of the discharge pipe line and the supply pipe line is externally arranged in the axle housing, it is possible to arrange the externally arranged discharge pipe line and supply pipe line at the position where the contact with the obstacle can be prevented.

As the installed place of the lubricating pump, since the suction outlet port of the suction pipe line is formed in the outer peripheral surface of the axle housing, in the case that the lubricating pump is arranged on the outer peripheral surface of the axle housing, it is possible to form the suction outlet port of the suction pipe line and the discharge port of the lubricating pump in the installed place of the lubricating pump. Accordingly, it is possible to easily place the lubricating pump on the outer peripheral surface of the axle housing wherever the lubricating pump can be placed, and the repairing process of the lubricating pump is improved.

It is possible to supply the lubricating oil in any state in the forward and backward movements of the vehicle, by employing the reversible type pump as the lubricating pump, and it is possible to intend to improve the performance of the vehicle. Further, it is possible to optionally set a rotating speed of the lubricating pump by setting the lubricating pump to the electric motor-driven type.

In accordance with the present invention, the strainer filtering the lubricating oil can be provided within the suction pipe line. Accordingly, it is possible to prevent the foreign particle or the like from being sucked into the lubricating pump together with the lubricating oil, and it is possible to prevent the lubricating pump or the drive apparatus from being damaged due to an influence of the foreign particle or the like.

### BRIEF DESCRIPTION OF THE DRAWINGS

FIG. 1 is an outline view of a wheel loader provided with an axle interior lubricating device (first embodiment).

FIG. 2 is a plan cross sectional view showing a lubricating pump attaching structure (first embodiment).

FIG. 3 is a partly cross sectional view of a side surface of a differential housing portion of an axle (first embodiment).

FIG. 4 is a view seen in the direction of the arrow taken along A-A of FIG. 3 (first embodiment).

FIG. 5 is a partly enlarged view seen in the direction of the arrow taken along B-B of FIG. 3 (first embodiment).

FIG. 6 is a partial view of a plan cross sectional view in which a lubricating pump is attached to a shaft housing (first embodiment).

FIG. 7 is a front elevational view of the axle (first embodiment).

FIG. 8 is a system view of the axle interior lubricating device (first embodiment).

FIG. 9 is a partial view of a plan cross sectional view showing a lubricating pump attaching structure (second embodiment).

FIG. 10 is a partly cross sectional view of a side surface of a differential housing portion to which a pipe joint block is attached (third embodiment).

FIG. 11 is a view seen in the direction of the arrow taken along C-C of FIG. 10 (third embodiment).

FIG. 12 is a system view of an axle interior lubrication in the case that the axle and an independently placed cooling apparatus are connected (third embodiment).

FIG. 13 is a cross sectional view showing a structure of a main portion of a lubrication adjusting type differential limiting device (prior art 1).

FIG. 14 shows a back elevational view in a pressure lubricating device (prior art 2).

### DESCRIPTION OF REFERENCE NUMERALS

10, 11 axle

12 axle housing

13 shaft housing

15 differential housing

16 mounting seat

17 boss portion

18 pinion housing

20 drive apparatus

21 differential case

23a, 23b differential gear

24 axle

25 drive shaft

26 ring gear

27 pinion

28 transmission shaft

30 30a lubricating pump

31 pump shaft

34 small gear

35 shaft

36 large gear

37 large gear

38 hydraulic multi disc clutch

40 strainer chamber

41 strainer

42 suction outlet port

43 suction pipe line

44 discharge port

45 discharge pipe line

46 first discharge port

47 second discharge port

48 suction inlet port

50 brake chamber

52 first piping

53 second piping

60 pipe joint block

61 suction passage

62 suction port

63 discharge passage

64 intake port

65 hydraulic pump

66 suction circuit

67 discharge circuit

68 oil cooler

70 planetary gear type center differential

71 hollow shaft

72 hollow member

73 hollow shaft

74 front differential

75 front differential case

78A ring gear

78B planetary pinion

78C sun gear

78D planetary carrier

79 center differential case

80 hydraulic multi disc clutch

81 gear pump

85 propeller shaft

89R right front wheel drive shaft

89L left front wheel drive shaft

91 lubricating pump

90 housing

94 pipe joint

92 feed oil pipe

93 rear wall

### BEST MODE FOR CARRYING OUT THE INVENTION

A description will be given below of an embodiment of one example of an axle interior lubricating device in accordance with the present invention with reference to the accompanying drawings. An outer appearance view is shown by taking a wheel loader 1 as an example of a wheeled vehicle provided with an axle interior lubricating device. A description will be given below of the axle interior lubricating device in accordance with the present invention by using a structure of the wheel loader 1, however, the axle interior lubricating device in accordance with the present invention is not limitedly applied to the wheel loader, but can be applied to the axle housing of the wheeled vehicle.

### First Embodiment

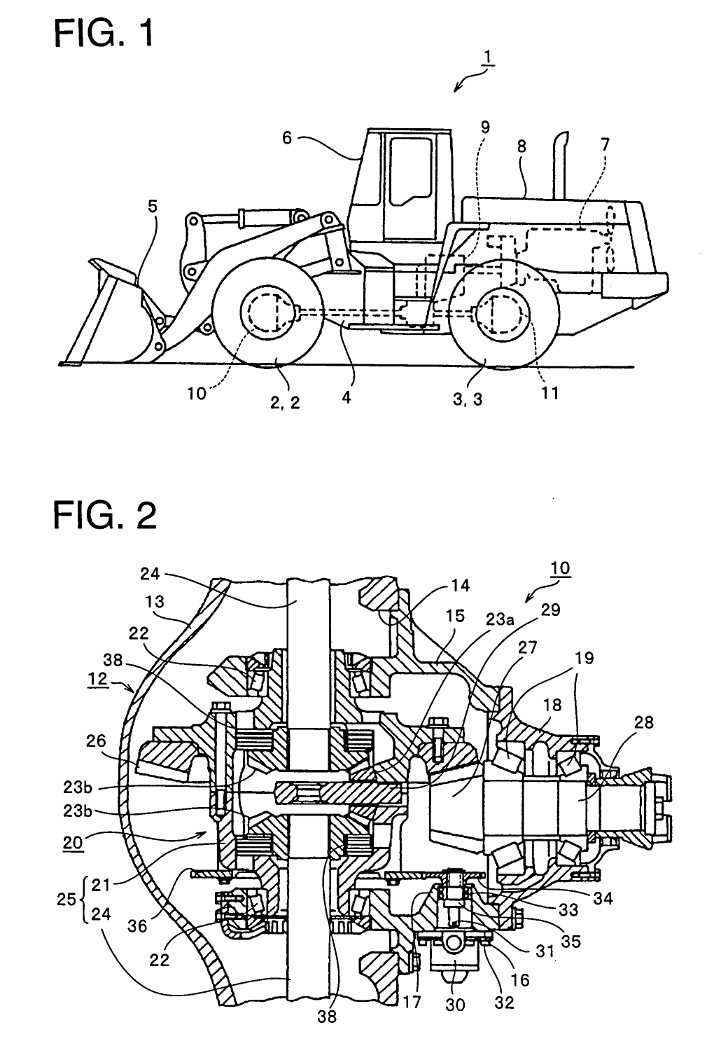

In FIG. 1, a working machine 5 is provided in a front portion of a vehicle body 4 having a pair of right and left front wheels 2 and 2 and a pair of right and left rear wheels 3 and 3. A driver's cabin 6 is mounted in an approximately center portion of the vehicle body 4, and an engine room 8 storing an engine 7 therein is mounted in a rear portion. The front wheels 2 and 2 and the rear wheels 3 and 3 are respectively attached to both right and left end portions in a forward axle 10 and a rearward axle 11, and are driven by a power of the engine 7 transmitted to the axles 10 and 11 via a transmission 9.

As shown in FIG. 2 showing a plan cross sectional view of the axle 10, a driving force from the engine (not shown) is introduced into the axle housing 12 by a transmission shaft 28. The transmission shaft 28 is rotatably supported to a pinion housing 18 via a pair of bearings 19 and 19. The axle housing 12 is structured by a shaft housing 13, a differential housing 15 and a pinion housing 18 which are mentioned below.

A pinion 27 attached to a leading end portion of the transmission shaft 28 is engaged with a ring gear 26 attached to a differential case 21, and can transmit the driving force from the engine through the transmission shaft 28 to the differential case 21. The differential case 21 is rotatably supported by a portion protruding into the shaft housing 13 of the differential (the differential mechanism) housing 15 via a pair of bearings 22 and 22. The differential housing 15 is detachably mounted to an opening portion 14 provided in the shaft housing 13.

A differential gear 23a is rotatably supported to a support shaft 29 attached toward an inner side of the differential case 21 by setting the support shaft 29 as a rotating shaft. The differential gear 23a is engaged with differential gears 23b and 23b respectively attached to a pair of axles 24 and 24. A differential gear mechanism is structured by the differential gears 23a, 23b and 23b. A rotation of the differential case 21 rotated by the driving force from the engine is transmitted to the differential gears 23b and 23b from the differential gear 23a via the differential gear mechanism, and it is possible to rotate each of the axles 24 and 24.

Further, the differential gear mechanism can achieve an effect capable of absorbing a difference of rotation generated between the axle 24 and the axle 24.

A hydraulic multi disc clutch 38 is arranged between the differential case 21 and each of the differential gears 23b and 23b, and a drive shaft 25 is structured by the differential case 21 and a pair of axles 24 and 24.

A lubricating pump 30 is detachably fastened to a mounting seat 16 provided in an outer side surface portion of the differential housing 15 by a bolt 32. A bearing 33 is arranged in a boss portion 17 provided in an inner side of the mounting seat 16, and a shaft 35 in which a small gear 34 is splined to a leading end portion is rotatably attached via the bearing 33. A base end portion of the shaft 35 is structured so as to be continuously brought into contact with a pump shaft 31 of the lubricating pump 30.

A large gear 36 is attached to the differential case 21 corresponding to one member of the drive shaft 25, and is engaged with the small gear 34 of the shaft 35 protruding into the axle housing 12. Accordingly, it is possible to pick up the rotation of the differential case 21 as the driving force of the lubricating pump 30. Since the lubricating pump 30 is structured as a reversible type pump, it is possible to actuate the lubricating pump 30 even if in whichever direction of the forward and backward directions the vehicle travels and the differential case 21 is just reversed.

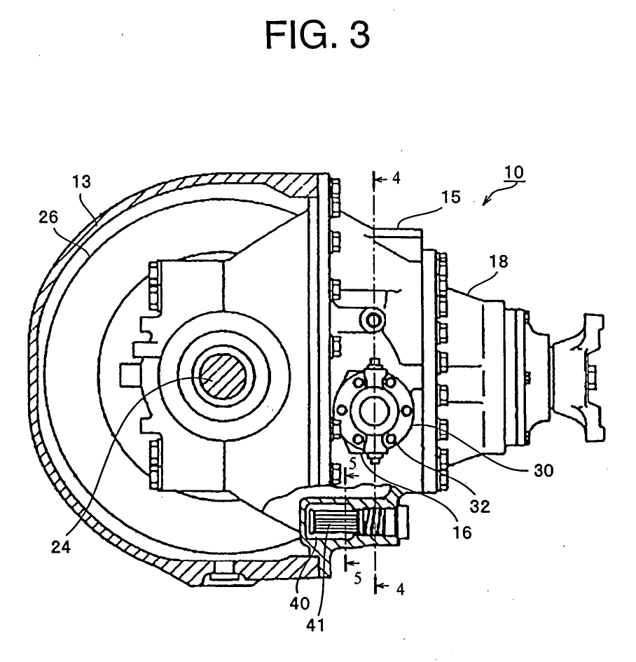

FIG. 3 is a partly cross sectional view of a side surface of the differential housing 15 portion of the axle 10. The lubricating pump 30 is attached to the mounting seat 16 provided in the side surface portion of the differential housing 15 via six bolts 32. As shown in FIG. 3, a strainer chamber 40 mentioned below is provided in a lower side of the lubricating pump 30, and a strainer 41 filtering the lubricating oil is detachably mounted in the strainer chamber 40. The strainer chamber 40 is provided near a bottom portion of the differential housing 15.

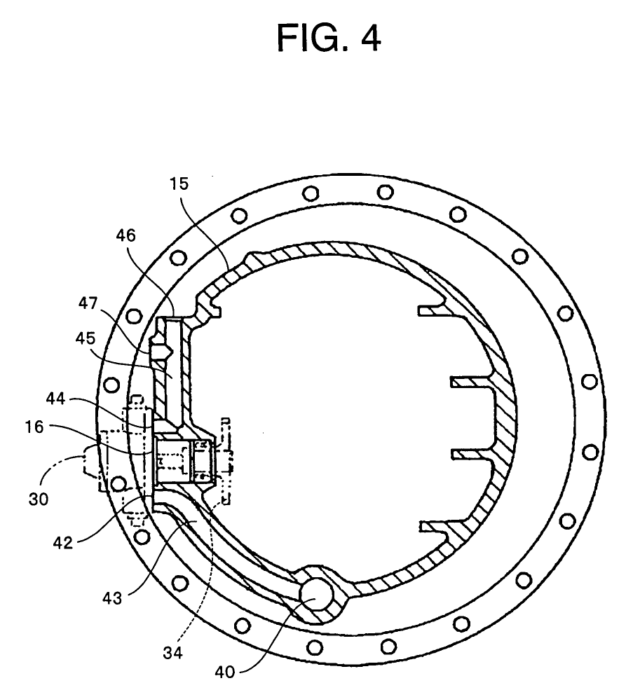

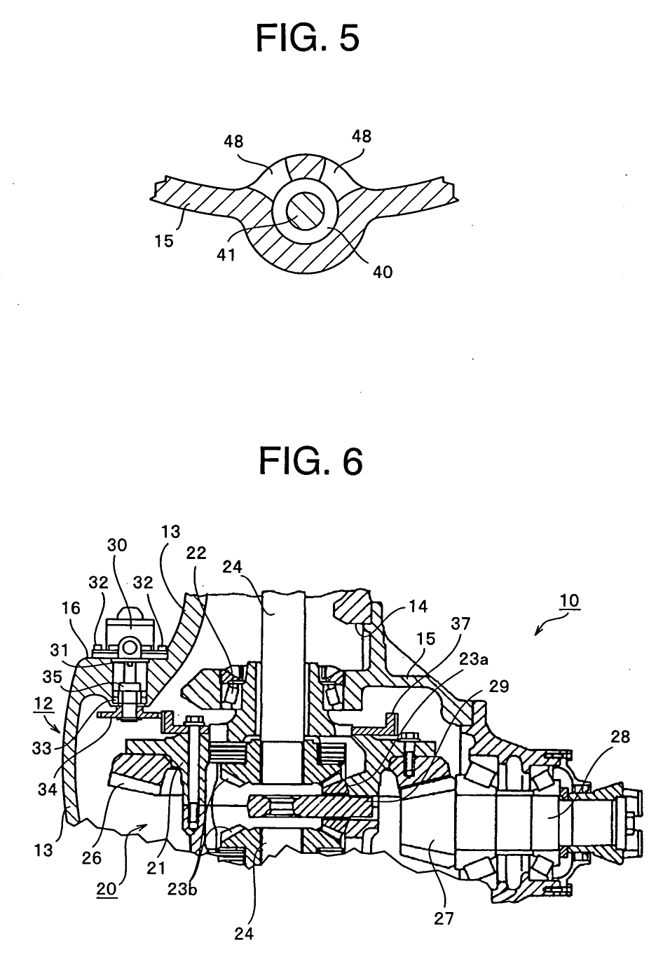

FIG. 4 is a view seen in the direction of the arrow taken along A-A of FIG. 3 and corresponds to a partly cross sectional view of a side surface of the differential housing 15 portion of the axle 10, and FIG. 5 is a view seen in the direction of the arrow taken along B-B of FIG. 3. As shown by FIGS. 4 and 5, a suction inlet port 48 is formed in a bottom portion side inner peripheral surface of the differential housing 15, and the suction inlet port 48 is connected to a suction outlet port 42 formed in the outer peripheral surface of the differential housing 15 via a suction pipe line 43. The suction outlet port 42 is formed in the mounting seat 16 to which the lubricating pump 30 is attached, and is formed at an upper position than the position where the suction inlet port 48 is formed. A formed number and a formed position of the suction inlet port 48 are not limited to the illustrated embodiment, but a necessary number of suction inlet ports can be formed at desired formed positions.

Accordingly, the lubricating pump can be arranged at the position having no risk of coming into collision with the obstacle on the ground, and it is possible to suck the lubricating oil stored within the differential housing 15 via the suction outlet port 42. Further, since the suction pipe line 43 can be installed within the differential housing 15, it is possible to prevent the suction pipe line 43 of the differential housing 15 from being damaged even if the obstacle on the ground is rubbed with the bottom portion of the differential housing 15.

Further, a protection cover or the like required in the case that the external piping is executed is not necessary, and it is unnecessary to secure the height from the ground surface required for arranging the protection cover. Accordingly, it is possible to make the cost low in comparison with the case that the protection cover is arranged. The suction pipe line 43 may be molded integrally with the differential housing 15 by casting, or may be integrally formed in the inner portion of the differential housing 15 by welding or the like.

The strainer chamber 40 is formed in the suction inlet port 48 side in the suction pipe line 43. As shown in FIG. 5, a strainer 41 is detachably mounted in the strainer chamber 40. Further, the suction inlet port 48 open to the bottom portion side inner peripheral surface of the differential housing 15 is formed in the strainer chamber 40. The suction inlet port 48, the suction pipe line 43 provided with the strainer chamber 40 and the suction outlet port 42 are formed integrally with the differential housing 15 by casting or the like.

Since the strainer 41 filtering the lubricating oil is provided within the suction pipe line 43, the foreign particle or the like is prevented from being sucked into the lubricating pump together with the lubricating oil, and it is possible to prevent the lubricating pump or the drive apparatus from being damaged due to the influence of the foreign particle or the like. Accordingly, it is possible to improve reliability and a durability of the axle interior lubricating device and the drive apparatus.

Further, the strainer 41 can simplify a layout structure on the basis of a compact layout, and can reduce the manufacturing cost. The strainer 41 can be arranged in the suction inlet port 48 of the suction pipe line 43, and can be arranged in the suction outlet port 42 of the suction pipe line 43. In the present invention, the structure in which the strainer 41 is arranged in the suction inlet port 48 or the suction outlet port 42 is included in the structure in which the strainer 41 is arranged within the suction pipe line 43.

As shown in FIG. 4, a discharge port 44 introducing the lubricating oil discharged from the lubricating pump 30 is formed in an upper position of the mounting seat 16, and a discharge pipe line 45 is connected to the discharge port 44. Each of a first discharge port 46 and a second discharge port 47 is formed in an end portion of the discharge pipe line 45. Further, the discharge port 44, the discharge pipe line 45, the first discharge port 46 and the second discharge port 47 are formed integrally with the differential housing 15 by casting. The discharge pipe line 45 can be molded integrally with the differential housing 15 in accordance with a casting or may be formed integrally in the inner portion of the differential housing 15 by welding or the like, in the same manner as the suction pipe line 43.

Accordingly, the discharge pipe line 45 can be formed within the differential housing 15, as at least a part of the supply pipe line arranged for supplying the lubricating oil discharged from the lubricating pump to the drive apparatus. Accordingly, even if a part of the supply pipe line is outside arranged in the axle housing 12, it is possible to arrange the outside arranged supply pipe line at a position where the contact with the obstacle can be prevented.

As a vertical cross sectional shape of the suction pipe line 43 and the discharge pipe line 45, it is possible to form a circular cross section, a flat cross sectional shape or the like, however, it is desirable to form the vertical cross sectional shape as the flat cross sectional shape in view of reducing a thickness of the differential housing 15 portion in which the suction pipe line 43 and the discharge pipe line 45 are formed, and in view of cooling the lubricating oil flowing within the suction pipe line 43 and the lubricating oil discharged from the lubricating pump 30 by the differential housing 15.

It is possible to structure so as to prevent the thickness of the axle housing, in which the suction pipe line 43 and the discharge pipe line 45 are formed, from being increased in a state of making the cross sectional area of the suction pipe line 43 and the discharge pipe line 45 large, by making the cross sectional shape of the suction pipe line 43 and the discharge pipe line 45 in the flat shape. In particular, since the cross sectional area of the suction pipe line 43 and the discharge pipe line 45 can be formed large, it is possible to make the flow of the lubricating oil easily flow within the suction pipe line 43 and the discharge pipe line 45 even if a viscosity of the lubricating oil becomes higher in a cold district, a winter weather or the like. Further, since it is possible to form the suction pipe line 43 and the discharge pipe line 45 within the axle housing even if the thickness of the axle housing is not increased, it is possible to secure a sufficient interval between the bottom surface of the axle housing and the ground surface.

The example is shown in which the mounting seat 16 to which the lubricating pump 30 is attached is formed in the differential housing 15, however, the mounting seat 16 can be formed in the shaft housing 13 as shown in FIG. 6. At this time, in the shaft housing 13, the suction pipe line 43 and the discharge pipe line 45 (which are not illustrated) may be formed integrally with the differential housing 15, in the same manner as shown in FIG. 4.

The lubricating pump 30 can be detachably fastened to the mounting seat 16 by the bolt 32. The bearing 33 is arranged in the boss portion 17 provided in the inner side of the mounting seat 16, and the shaft 35 to which the small gear 34 is splined to the leading end portion is rotatably attached via the bearing 33. The base end portion of the shaft 35 is structured so as to be continuously brought into contact with the pump shaft 31 of the lubricating pump 30.

Accordingly, a commercially available lubricating pump can be used as the lubricating pump 30, for example, it is possible to suitably use a reversible type trochoid pump of TOP·2RA·12C type manufactured by Nihon Oil Pump Co., Ltd., or the like.

Since the commercially available lubricating pump can be utilized as the lubricating pump 30, it is possible to make the cost low. Further, since it is possible to freely set the mounting position of the lubricating pump, it is possible to increase a freedom of design.

The large gear 37 is attached to the differential case 21 corresponding to one member of the drive shaft 25, and is engaged with the small gear 34 of the shaft 35 protruding into the shaft housing 13. Accordingly, it is possible to pick up the rotation of the differential case 21 as the driving force for the lubricating pump 30. Since the lubricating pump 30 is structured as the reversible type pump, it is possible to actuate the lubricating pump 30 even if in whichever direction of the forward and backward directions the vehicle travels and the differential case 21 is just reversed.

The mounting seat 16 can be formed on the differential housing 15 as shown in FIG. 2, can be formed on the shaft housing 13 as shown in FIG. 6, or can be formed on the pinion housing 18 which is not exemplified. Further, the mounting seat 16 to which the lubricating pump 30 is attached can be formed at the position on the axle housing 12 provided with the differential housing 15, the shaft housing 13 and the pinion housing, where the lubricating pump 30 does not come into collision with the obstacle on the ground 18.

Further, as a drive source driving the lubricating pump 30, the structure picking up the rotation of the differential case 21 is exemplified, however, the lubricating pump 30 can be driven by a structure of driving the lubricating pump 30 by picking up the rotation of the transmission shaft 28 to which the rotation from the engine is transmitted, in addition to the rotation of the differential case 21.

Since it is possible to drive the lubricating pump 30 on the basis of the driving force of the wheel drive apparatus, it is possible to drive the rotational speed of the lubricating pump in proportion to the vehicle speed. In particular, when the brake load is large (for example, at the braking time under high-speed running), a high cooling property can be obtained by increasing a circulating flow amount of the lubricating oil.

Further, at a low-speed running time when the brake load is small, it is possible to make the rotational speed of the lubricating pump 30 small, and it is possible to reduce a pump loss so as to improve a pump efficiency. It is possible to supply the lubricating oil whichever state in the forward and backward movements of the vehicle, by employing the reversible type pump as the lubricating pump 30, whereby it is possible to intend to improve the performance of the vehicle.

It is possible to optionally set the rotational speed of the lubricating pump 30 by setting the lubricating pump 30 to the electric motor-driven type lubricating pump. Accordingly, it is possible to supply the requisite minimum lubricating oil at a necessary time, it is possible to reduce a power loss, and it is possible to intend to improve a working efficiency of the lubricating pump.

The suction pipe line 43 communicating the suction inlet port 48 with the suction outlet port 42 can be formed integrally with the axle housing 12. Accordingly, even if the mounting seat 16 is formed at a desired position of the axle housing 12, it is possible to form the suction outlet port 42, which is connected to the suction inlet port 48 formed in the bottom portion side inner peripheral surface within the axle housing 12, in the mounting seat 16.

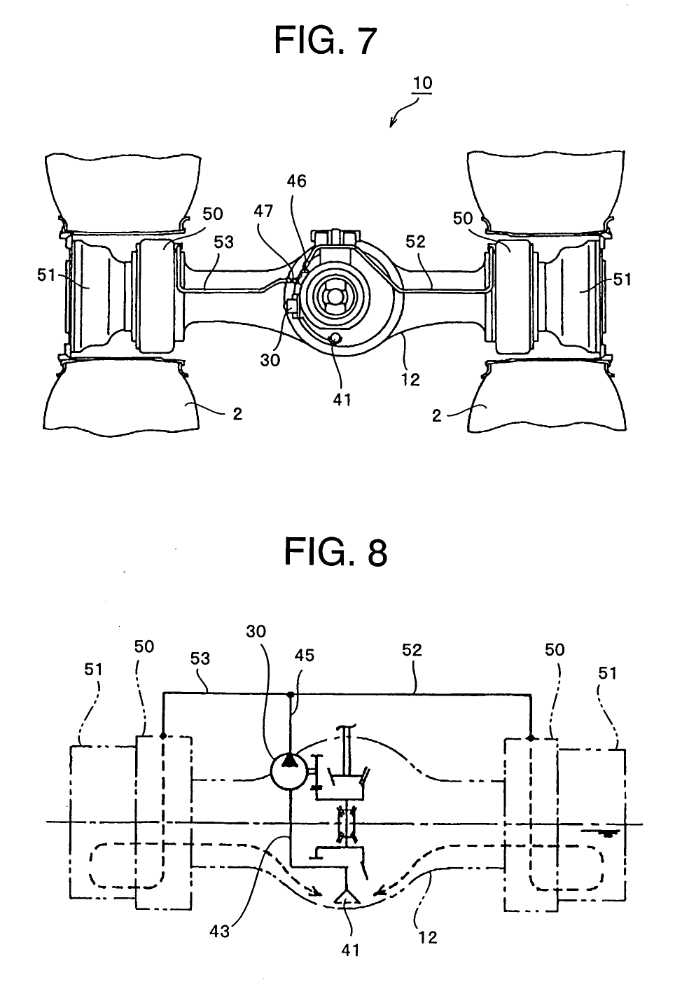

Next, a description of the structure of the axle interior lubricating device will be given by exemplifying the axle 10 to which the front wheels 2 and 2 are attached. The axle interior lubricating device in accordance with the present invention can be applied to the axle 11 to which the rear wheels 3 and 3 are attached. FIG. 7 is a front elevational view showing a schematic structure of a main portion of the axle 10. In FIG. 7, brake chambers 50 and 50 are provided in both right and left end portions of the axle housing 12, and final reduction gears 51 and 51 are provided in an outer side thereof. The front wheel 2 is attached to each of the final reduction gears 51.

For example, a multi disc type friction brake (not shown) is stored in the brake chamber 50. A first discharge port 46 provided in the differential housing 15 and one brake chamber 50 are connected by a first piping 52 arranged in an upper portion of the axle housing 12. Further, a second discharge port 47 and the other brake chamber 50 are connected by a second piping 53 arranged in the upper portion of the axle housing 12. Further, since the first piping 52 and the second piping 53 which are externally arranged, are arranged in the upper portion of the axle housing 12, a risk that the piping is damaged by the obstacle is prevented.

FIG. 8 shows a system structure view of the axle interior lubricating device. In FIG. 8, the lubricating oil stored within the axle housing 12 is filled up to an oil level position. The lubricating oil sucked from the suction inlet port (not shown) is filtered by the strainer 41 arranged in the strainer chamber 40 and is thereafter sucked by the lubricating pump 30 via the suction pipe line 43.

The lubricating oil discharged from the lubricating pump 30 is introduced to the first piping 52 and the second piping 53 from the discharge port 44 via the discharge pipe line 45, and is discharged respectively into the brake chambers 50 and 50 corresponding to a connected portion to the first piping 52 and the second piping 53. At this time, the lubricating oil passing through the suction pipe line 43 and the discharge pipe line 45 can radiate heat from the surface of the differential housing 15 having the suction pipe line 43 and the discharge pipe line 45 built-in, and becomes in a cooled state so as to be discharged into the brake chamber 50.

The lubricating oil discharged into the brake chamber 50 cools the brake (not shown) stored in the brake chamber 50, as shown by a broken line. The lubricating oil at high temperature after cooling, is mixed with the lubricating oil, which is at comparatively low temperature and stored within the axle housing 12 via the final reduction gear 51. Accordingly, it is possible to reduce the temperature of the lubricating oil at high temperature by cooling the brake within the brake chamber 50. Further, the temperature of the mixed lubricating oil is averaged during the time when the lubricating oil is stored within the axle housing 12.

Further, since it is possible to radiate heat from an entire surface area of the axle housing 12, it is possible to always store the lubricating oil in a state in which the cooling efficiency is good, while utilizing an entire of the outer surface of the axle housing 12 as a heat radiating area of the lubricating oil. Further, the cooled lubricating oil is supplied, for example, to the multi disc type friction brake portion of the drive apparatus, and it is possible to improve a high cooling effect without any oil cooler.

Since the suction pipe line is formed within the axle housing 12 along the outer surface of the axle housing 12, it is possible to significantly improve vehicle performance at a low cost, and it is possible to run for a long time and continuously drive down a hill a long distance under a high-temperature environment.

In the case that the lubricating pump 30 is arranged in the outer peripheral surface of the axle housing 12, the suction outlet port 42 of the suction pipe line 43 can be used as the supply port to the lubricating pump 12, and the discharge port 44 in the input side of the discharge pipe line 45 can be used as the discharge port from the lubricating pump 30. Further, it is possible to easily form the suction outlet port 42 and the discharge port 44 on the attaching portion of the lubricating pump 30. Further, a pipe joint block 60 is attached to the position where the suction outlet port 42 and the discharge port 44 are formed, thereby being constituted as a connection port at a time of outside arranging the lubricating pump 30 and the cooling apparatus for the lubricating oil.

### Second Embodiment

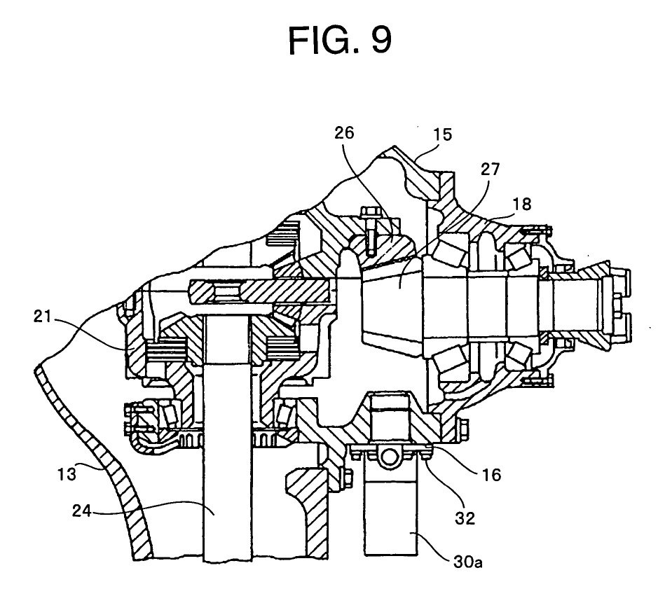

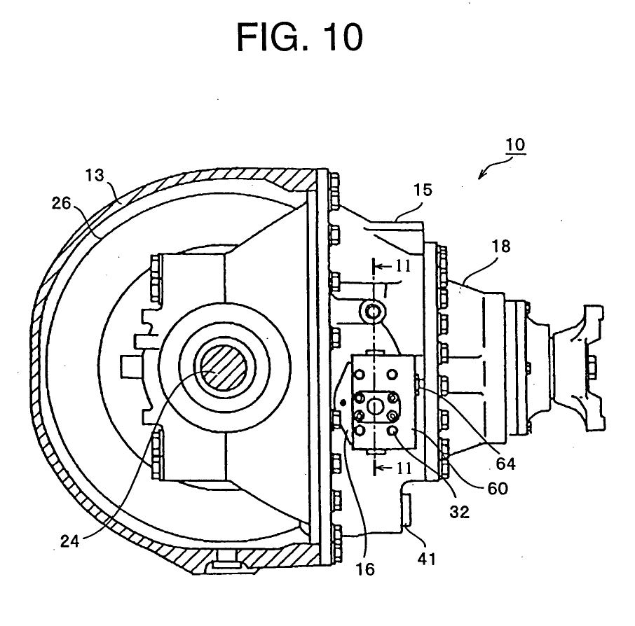

FIG. 9 is a plan cross sectional view showing a lubricating pump attaching structure in accordance with a second embodiment of the present invention. The second embodiment is characterized in that the lubricating pump is constituted by an electric motor-driven lubricating pump. The same reference numerals as those used in the first embodiment are attached to the same structures in the second embodiment as those of the first embodiment, and a description thereof will be omitted. A description of different portions from the first embodiment will be given mainly below.

In FIG. 9, an electric motor-driven type lubricating pump 30a is fastened to the mounting seat 16 of the differential housing 15 via the bolt 32. The lubricating pump 30a is provided with an electric motor for driving the pump, and it is possible to control the drive of the lubricating pump 30a by controlling the electric motor by a switch (not shown), a control apparatus or the like. In the second embodiment, the structures such as the small gear 34, the large gear 36 and the like arranged for driving the lubricating pump 30 in the first embodiment are not required.

Further, since it is possible to arrange the switch, the control apparatus and the like for controlling the drive of the electric motor independent from the lubricating pump 30a, it is possible to control an actuation state of the lubricating pump 30a in accordance with a previously set program or the like, or on the basis of an operation of an operator.

The description of the example is given, in which the electric motor-driven type lubricating pump 30a is attached to the mounting seat 16 of the differential housing 15, however, the position to which the electric motor-driven type lubricating pump 30a can be attached is not limited to the differential housing 15, but can be attached to the shaft housing 13 and the pinion housing 18. Further, the suction outlet port and the discharge port described in the first embodiment can be formed in the mounting seat 16.

### Third Embodiment

FIG. 10 is a partly cross sectional view of a side surface showing a structure of a third embodiment in accordance with the present invention. The third embodiment is characterized in that the pipe joint block 60 is attached to the mounting seat 16. In the structure of the third embodiment, the same reference numerals as those used in the first embodiment and the second embodiment are attached to the same structures as those of the first embodiment and the second embodiment, and a description thereof will be omitted. A description of different portions from the first embodiment and the second embodiment will be given mainly below.

In the third embodiment, the pipe joint block 60 is detachably fastened to the mounting seat 16 of the differential housing 15 by four bolts 32. The four bolts 32 can utilize four bolts in six bolts 32 used at a time of fastening the lubricating pump 30 to the mounting seat 16. The pipe joint block 60 can be attached by utilizing the mounting seat 16 to which the lubricating pump 30 can be attached.

In this case, a description of the mounting seat 16 to which the pipe joint block 60 is attached will be given by exemplifying the structure formed in the differential housing 15, however, the mounting seat 16 to which the pipe joint block 60 can be attached may be formed in the shaft housing 13 and the pinion housing 18 in addition to the differential housing 15. Further, at this time, the suction pipe line 43 and the discharge pipe line 45 can be formed integrally with the axle housing 12 in which the mounting seat 16 is formed. Further, the strainer chamber can be formed within the suction pipe line 43, and the strainer can be detachably arranged within the strainer chamber.

The suction pipe line 43 and the discharge pipe line 45 can be formed in one housing in the axle housing 12 in which the mounting seat 16 is formed. Further, the suction pipe line and/or the discharge pipe line can be formed even in a housing adjacent to the one housing, and the pipe lines in the adjacent housings can be communicated with each other.

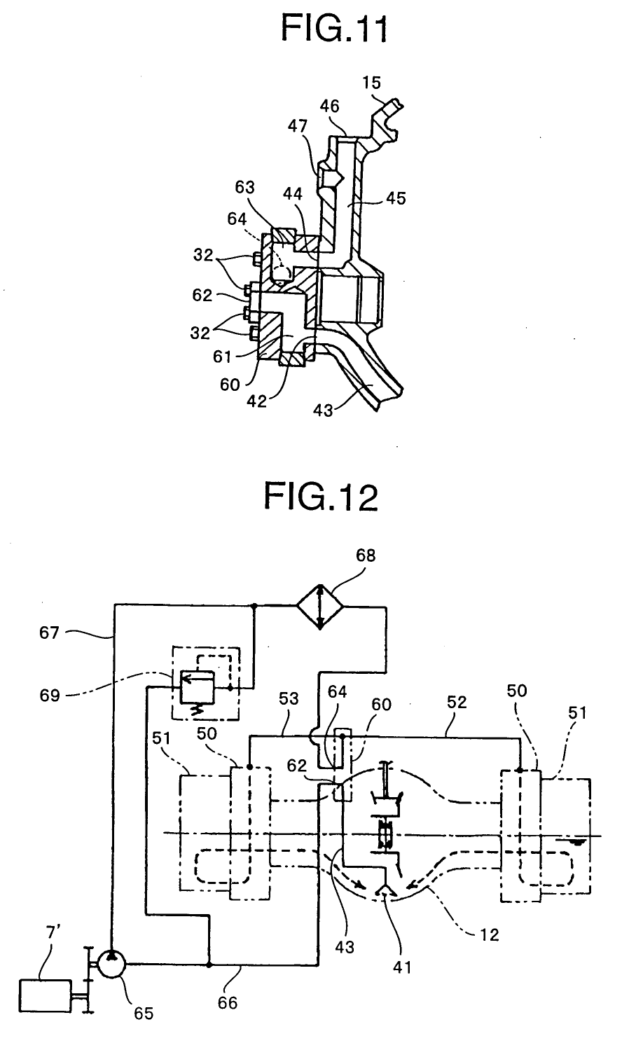

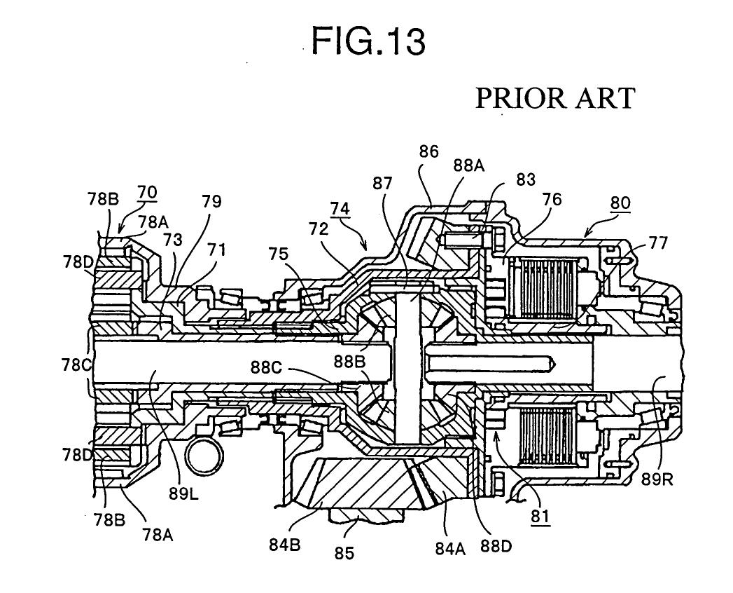

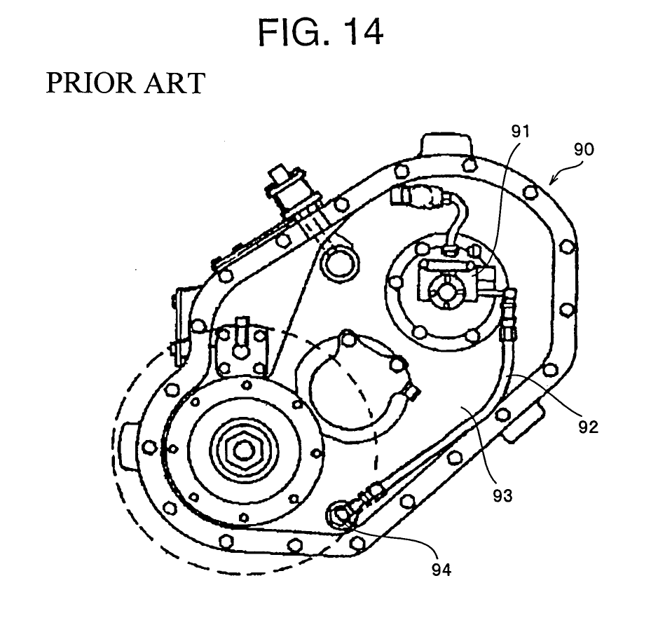

FIG. 11 is a view seen in the direction of the arrow taken along C-C of FIG. 10. The same reference numerals are attached to the same members as those of the first embodiment described in FIG. 4, and a description thereof will be omitted. In FIG. 11, the pipe joint block 60 is provided with a suction passage 61, a suction port 62 and a discharge passage 63. The suction passage 61 and the suction port 62 are connected to the suction outlet port 42 provided in the mounting seat 16, and the discharge passage 63 is connected to the discharge port 44 provided in the mounting seat 16. The discharge passage 63 is connected to an intake port 64 (also illustrated in FIG. 10) provided in a side surface portion of the pipe joint block 60.

The lubricating pump and/or the cooling apparatus can be arranged independently from the axle 10, by being arranged via the pipe joint block 60. In FIG. 12, a system view of an axle internal lubrication is shown by exemplifying the case that the lubricating pump and the cooling apparatus are arranged independently from the axle 10. In this case, the same reference numerals are attached to the same members as those described in the system view of the axle internal lubrication in accordance with the first embodiment described on the basis of FIG. 8, and a description thereof will be omitted.

In FIG. 12, the suction port 62 of the pipe joint block 60 is connected via independently arranged hydraulic pump 65 and suction circuit 66. The hydraulic pump 65 constitutes the lubricating pump, and is driven by a drive apparatus 7′ such as an engine, a drive motor or the like. A discharge port of the hydraulic pump 65 is connected to a discharge circuit 67, and the discharge circuit 67 is connected to the intake port 64 of the pipe joint block 60 via an oil cooler 68. Reference numeral 69 denotes a relief valve adjusting a pressure within the discharge circuit 67.

Next, a description of an actuation of the axle internal lubricating system will be given. The lubricating oil stored within the axle housing 12 is sucked via the strainer 41 by an actuation of the hydraulic pump 65, and the sucked lubricating oil is discharged into the discharge circuit 67 from the discharge port of the hydraulic pump 65.

The lubricating oil pressure fed into the discharge circuit 67 is cooled by the oil cooler 68, and is supplied to the intake port 64 of the pipe joint block 60. Since a flow of the lubricating oil after being supplied to the intake port 64 is the same as the flow of the lubricating oil in the first embodiment described in FIG. 8, a description thereof will be omitted.

It is possible to enlarge the cooling capacity in the lubricating oil by interposing the cooling apparatus as in the third embodiment. Further, it is possible to easily replace with a lubricating pump having a desired capacity and a cooling apparatus having desired cooling performance, by arranging the pipe joint block 60 as in the third embodiment.

Even in the case that the lubricating pump is installed in the different place from the axle housing 12, it is possible to form the suction port 62 of the suction pipe line 43 at the position where the suction port 62 is not brought into contact with the obstacle on the ground. Accordingly, it is possible to arrange the pipe line connecting the independently placed lubricating pump to the suction outlet port at the position where the contact with the obstacle can be prevented.

As mentioned above, it is possible to easily install the lubricating pump in the detachable place, and it is possible to additionally attach the lubricating pump only at a necessary time. In the case that the lubricating pump is not attached, the suction outlet port can be sealed by a seal member or the like.

Further, for example, even in the case that the greater cooling performance is required, for example, in the case of driving down a hill for a long time in a high load condition, it is possible to easily connect the independently placed hydraulic pump and oil cooler to the suction outlet port and the discharge port by employing the structure in which the pipe joint block is arranged in the suction port 62 and the intake port 64. Accordingly, it is possible to easily obtain a great cooling capacity by using the independently placed hydraulic pump and oil cooler, and it is possible to improve a general-purpose property of the vehicle.

### INDUSTRIAL APPLICABILITY

The axle internal lubricating device in accordance with the present invention can be employed as the axle internal lubricating device in the various vehicles provided with the axle.

1. An axle interior lubricating device for a vehicular axle having wheels rotatably attached to both right and left end portions thereof and provided with an axle housing for storing a drive apparatus driving the wheels, wherein
a suction inlet port formed in an inner peripheral surface on a bottom portion side of the axle housing, a suction outlet port formed in an outer peripheral surface of the axle housing at an upper position than a forming position of the suction inlet port, and a suction pipe line communicating the suction inlet port with the suction outlet port are formed integrally with the axle housing, and
the suction outlet port is connected to a lubricating pump.

2. The axle interior lubricating device according to claim 1, wherein at least two discharge ports are formed in the outer peripheral surface of the axle housing at different positions above the forming position of the suction inlet port, the discharge ports and a discharge pipe line communicating the respective discharge ports are formed integrally with the axle housing, and discharge pressure oil from the lubricating pump is supplied to one of the discharge ports.

3. The axle interior lubricating device according to claim 1 or 2, wherein the lubricating pump is arranged on the outer peripheral surface of the axle housing.

4. The axle interior lubricating device according to claim 1 or 2, wherein the lubricating pump comprises a reversible type pump arranged on the outer peripheral surface of the axle housing, and is driven by a driving force of the drive apparatus.

5. The axle interior lubricating device according to claim 1 or 2, wherein the lubricating pump is an electric motor-driven lubricating pump.

6. The axle interior lubricating device according to claim 1 or 2, wherein a strainer for filtering lubricating oil is inside installed within the suction pipe line.
